(19) United States
(12) Patent Application Publication
(10) Pub. No.: US 2021/0096819 A1
(43) Pub. Date: Apr. 1, 2021

(54) NONLINEAR OPTICAL COMPONENTS FOR ALL-OPTICAL PROBABILISTIC GRAPHICAL MODEL

(71) Applicant: ARIZONA BOARD OF REGENTS ON BEHALF OF THE UNIVERSITY OF ARIZONA, Tucson, AZ (US)

(72) Inventors: Masoud BABAEIAN, Tucson, AZ (US); Nasser PEYGHAMBARIAN, Tucson, AZ (US); Robert A. Norwood, Tucson, AZ (US); Mark A. NEIFELD, Tucson, AZ (US); Pierre Alexandre BLANCHE, Tucson, AZ (US)

(21) Appl. No.: 17/054,309

(22) PCT Filed: May 13, 2019
(86) PCT No.: PCT/US2019/031961

§ 371 Date: Nov. 10, 2020

Related U.S. Application Data
(60) Provisional application No. 62/670,177, filed on May 11, 2018.

(51) Int. Cl. G06F 7/556; G06F 1/03

(52) U.S. Cl. CPC G06F 7/556; G06F 1/0307

(57) ABSTRACT

A method of multiplying together a series of factors includes representing a multiplication operation in terms of a summation of a series of natural logarithmic functions that undergo exponentiation to represent the multiplication of the factors. An optical signal is generated for each of the factors to be multiplied. Each optical signal has a power or energy level that represents its respective factor. Each of the optical signals is applied to a respective material that undergoes a two-photon absorption process to implement a natural logarithm function. Each optical output signal output by the materials is directed to an optical combiner to obtain a summed optical signal. The summed optical signal is directed to a saturable absorber to implement an exponential function. The power or energy of the resulting optical output signal from the saturable absorber represents the product of the factors to be multiplied.

### GOVERNMENT FUNDING

This invention was made with government support under Grant No. N00014-14-1-0505, awarded by NAVY/ONR. The government has certain rights in the invention.

### BACKGROUND

One of the major challenges in electronic computation is the optimization problem that usually occurs in a large data set where each variable depends on or has influence on other variables. The probabilistic graphical model (PGM) is a standard and extremely powerful approach to calculate the joint probability distribution for a large number of variables where each element of the set depends on other variables. PGM methods are used in a variety of fields including social networks, artificial intelligence, machine learning, decision-making, speech recognition, image processing, and computational biology. Electronic central processing units (CPUs) are not the best tools to address these problems. Introducing multicore technology and parallel computing architectures such as sub-threshold very large scale integration (VLSI), application-specific integrated circuit (ASIC) and a custom ASIC, the Tensor Processing Unit (TPU) from Google, have improved speed/power cost for optimization problems, but optimization problems for big data remain a big challenge. Heat generation and bandwidth limitations of electronic devices are the main reasons for this, and reports of Moore's law being exhausted have become common. For these reasons, hybrid optical-electronic accelerators have recently been explored to improve electronic digital computing in terms of speed enhancement and energy efficiency for several problems such as signal processing, spike processing and reservoir computing.

The sum-product message passing algorithm (SPMPA) is commonly used in graphical models. In this algorithm, a message (μ_{S→R}) containing the influence that node S exerts on node R is passed to R. When node R is connected to multiple nodes, the message received at R is the normalized product of the influences from all other nodes,

$$p ( {x}_{1} , {x}_{2} , … {x}_{n} ) = \frac{1}{Z} {\prod }_{n = 1}^{N} {x}_{n} \qquad ( 1 )$$

where Z is a normalization factor, p is the probability distribution and N is the total number of nodes. Graphically, each variable is represented by a node and its potential to be influenced by other nodes is represented by the connections to other nodes or edges. For instance, FIG. la shows a graph for image processing with each node representing a pixel in the image that is being influenced by its four nearest neighbors; thus 4 edges for each node with an alphabet K, defined by the potential intensity of each pixel, K=256 for 8-bit encoding in each pixel. FIG. 1b shows a fully connected graph that is applicable to, e.g., an Ising problem with each node representing an electron in a solid with its spin influenced by all other electrons with K=2 for spins up or down.

A fully optical implementation of PGMs, using a wavelength multiplexing architecture could offer a promising approach to efficiently solving large data set problems, potentially providing benefits such as increased speed and lower power consumption.

### SUMMARY

Probabilistic graphical models (PGMs) are tools that are used to compute probability distributions over large and complex interacting variables. They have applications in social networks, speech recognition, artificial intelligence, machine learning, and many other areas. Described herein is an all-optical implementation of a PGM through the sum-product message passing algorithm (SPMPA) governed by a wavelength multiplexing architecture.

In one aspect, an all-optical implementation of PGMs has been used to solve a two node graphical model governed by SPMPA and the message passing algorithm has been successfully mapped onto photonics operations. The essential mathematical functions required for this algorithm, including multiplication and division, are implemented using nonlinear optics in thin film materials. The multiplication and division functions are demonstrated through a logarithm-summation-exponentiation operation and a pump-probe saturation process, respectively.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1a shows an example of a graphical map that is locally connected and FIG. 1b shows a graphical map that is fully connected.

FIG. 2a shows a functional block diagram of an optical implementation of a multiplier operation; and FIG. 2b shows a functional block diagram of the sum-product message passing algorithm (SPMPA) for node m.

FIG. 3a shows a numerical simulation for the saturable absorber equation and its fit with an exponential function; FIG. 3b shows a comparison of the two photon absorption (TPA) solution with a natural logarithm function; and FIG. 3c shows the composite mathematical operations of ln-sum-exp for 29 inputs along with the ideal multiplication result plotted as a linear fit.

FIG. 4a shows one example of an optical arrangement for multiplying two factors represented by the energy levels of two optical signals; FIGS. 4b, 4c and 4d show Eₒᵤₜ versus Eᵢₙ and the nonlinear fit functions with the natural logarithm and exponential functions for the TPA materials (FIGS. 4b and 4c) and the SA material (FIG. 4d) shown in FIG. 4a; FIG. 4e shows the measured final output energy as a result of appropriate manipulations of the two inputs, versus the desired multiplication of the two numbers; FIG. 4f shows a modified functional block diagram of the optical implementation of the multiplier function shown in FIG. 2a, which include two gain stages.

FIG. 5a shows a functional block diagram of the optical implementation of the normalization function for two broadband (multi-wavelength) power inputs A and B that represent two numbers to be normalized; FIG. 5b shows a schematic of the wavelength remapping through the pump-probe saturation process, where each element of the probability vector is modulated in the presence of a broadband pump, requiring spatial separation in the saturable absorber (SA).

FIG. 6a shows one example of an experimental arrangement that was employed for normalizing two optical powers; FIG. 6b shows the simulation results of an ideal normalization of two input powers A and B; FIG. 6c shows the experimental results of normalizing two functions using the arrangement of FIG. 6a.

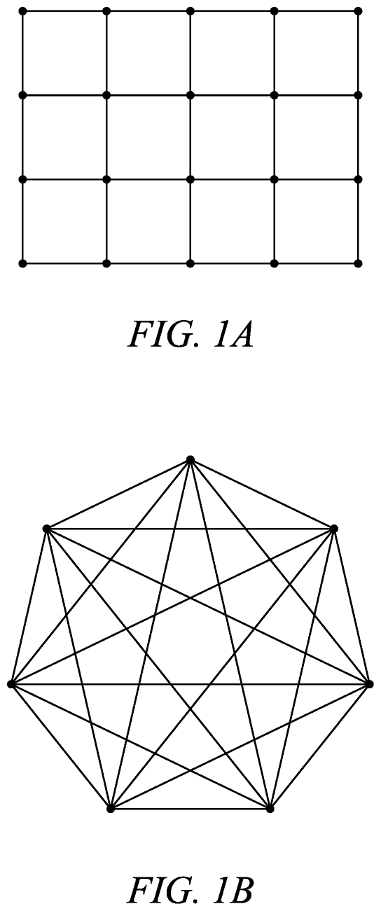

### DETAILED DESCRIPTION

Wavelength Multiplexing Architecture

The multiplier of the message passing algorithm of equation (1) can be written with natural logarithmic (ln), summation and exponential operations as,

$${\prod }_{m = 1}^{j} {Y}_{m} = exp ( {\sum }_{m = 1}^{j} ln ( {Y}_{m} ) ) \qquad ( 2 )$$

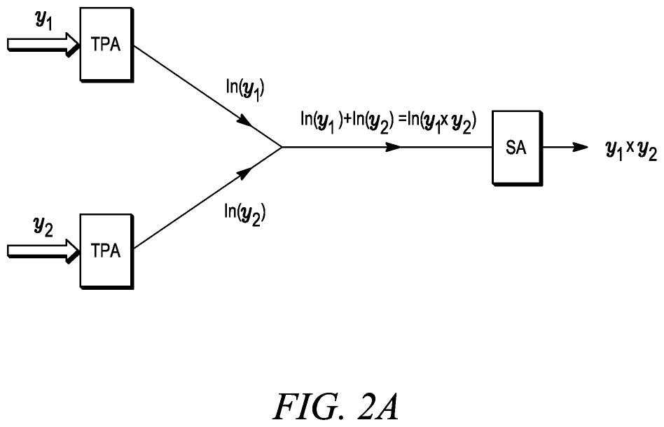

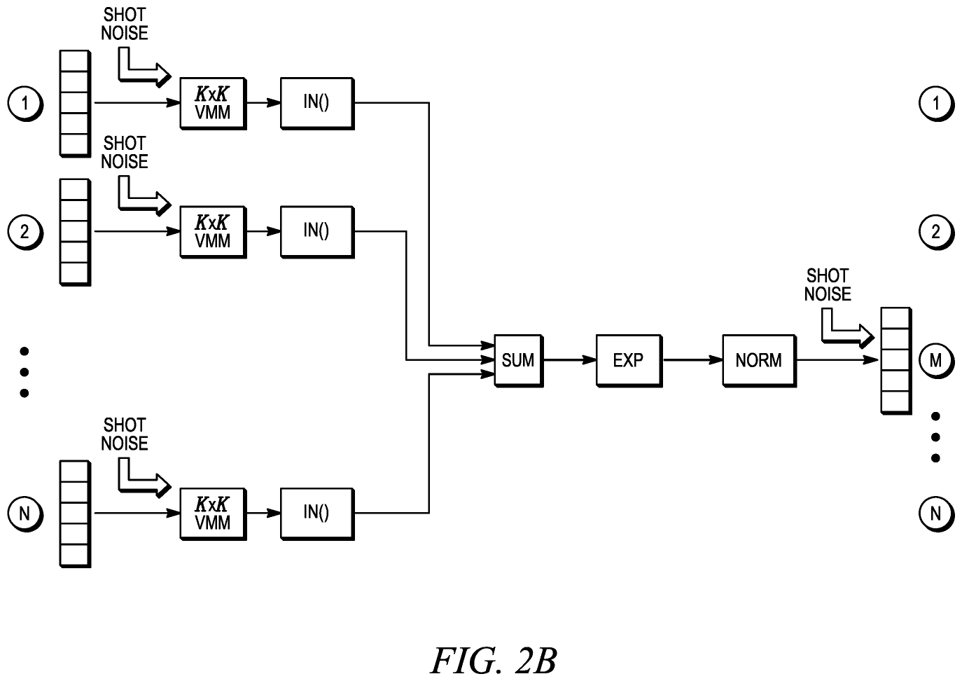

This embodiment of the multiplier is easier to implement optically. FIG. 2a shows a functional block diagram of an optical implementation of the multiplier operation. As shown, in this example two factors y1 and y2 are to be multiplied. Each factor is represented by an optical power or energy level of an optical signal. The optical signals y1 and y2 each directed to a two-photon absorption (TPA) process material. The output from each TPA material represents the natural logarithm of the respective factors. The optical outputs from each TPA material are then combined by an optical combiner to obtain the summation of the natural logarithm of the respective factors. This combined optical output is then directed to a saturable absorber (SA) to implement the exponential function. In this way the power or output from the saturable absorber represents the products of the factors to be multiplied. The multiplication process shown in FIG. 2a may be extended to multiply together any number of factors.

In the wavelength multiplexing architecture of FIG. 2b, each node 1, 2 . . . N is represented by a different wavelength, since the spectral bandwidth can be equally divided and used for each node. The graph in FIG. 2b has N nodes and the alphabet size is K. To find the updated probability vector of the target node (node m in FIG. 2b), each message from its neighbor nodes is first multiplied with a compatibility matrix whose elements are conditional probabilities. This operation is called vector-matrix-multiplication (VMM). The outputs of the VMM are then multiplied element-wise and normalized to yield the updated probability vector of the target node. The product of all messages is replaced with logarithmic, summation and exponential operations as shown in equation (2). These operations are applied to every node in order to determine its updated probability vector. The updated vectors are then used in subsequent iterations until their values reach steady state. Thus, the two most important mathematical operations required to compute the probability vector are multiplication and division for normalization. The natural logarithmic function can be implemented optically by two-photon-absorption (TPA), while the exponential function can be optically realized through saturable absorption (SA), and the summation function by the fan-in process.

One problem that arises when using analog optics to implement the mathematical functions and operations is that noisecan be induced, which can affect the performance of the optical solution of the PGMs. Therefore, simulations, described below, were performed to determine the effect of noise on the failure rate of the sum-product message passing algorithm. The results indicate a 99% success rate for a graph with one-million nodes, an alphabet size of 100 and 20% connection density. In other words, the optical implementation of the sum-product message passing algorithm is very tolerant to the noise.

The modeling performed to simulate the effects of noise on the performance and robustness of the optical implementation of the SPMPA indicates a new lower bound on power consumption. FIG. 2 shows where the shot noise is added to the algorithm. Shot noise is inserted for each node before the VMM operation where the photons are generated. After normalization units we also added shot noise to make sure that each node starts with the same number of photons for the next iteration. To analyze the effects of shot noise, photon number is used in the modeling for VMM, natural logarithm, exponential and normalization operations. The shot noise expression is inserted as nᵢ=n₀ᵢ+Gauss(0, \sqrt{n₀ᵢ}) where n₀ᵢ is the initial photon number injected to each node, i is the node number and Gauss(0, \sqrt{n₀ᵢ}) is the Gaussian distribution with standard deviation of \sqrt{n₀ᵢ} and zero mean value.

The numerical simulation was performed using a Monte Carlo method where a desired configuration was first initiated. This configuration was then used for the probability vector whose elements are all equal to 1/K except one node that we assume is known (e.g. a graph with K=3 in which probability vector would be [0.33, 0.33, 0.33]). The probability vector of the known node has one element which has higher value than the rest of the elements that is corresponded to its assigned alphabet (e.g. a graph with K=3 in which probability vector for the known node could be [0.5, 0.25, 0.25]). After several iterations (when the steady state was reached and the elements of the final probability vector for each node stabilized) the simulation converges to its probable alphabet for each node. The result is a failure or a success if the simulated configuration is respectively different from or matches the desired configuration. The analysis indicates a 99% success rate to optically implement the SPMPA for a graph with one million nodes, an alphabet size of 100 and 20% connections at the shot noise limit. In this regard we conclude that optical implementation of SPMPA through wavelength multiplexing is highly tolerant and robust to shot noise and imperfections.

Inserting the saturable absorption equation α(I)=α₀/(1+I/Iₛₐₜ) in the differential equation for the nonlinear absorption, dI/dz=−α(I)I and solving leads to

$${I}_{out} {e}^{\frac{{I}_{out}}{{I}_{sat}}} = {I}_{in} {e}^{\frac{{I}_{in}}{{I}_{sat}} - {α}_{0} L} \qquad ( 3 )$$

Here Iₛₐₜ is the saturation peak irradiance, α₀ is the weak field absorption, L is the thickness of SA material and Iᵢₙ and Iₒᵤₜ are the input and output peak irradiance respectively.

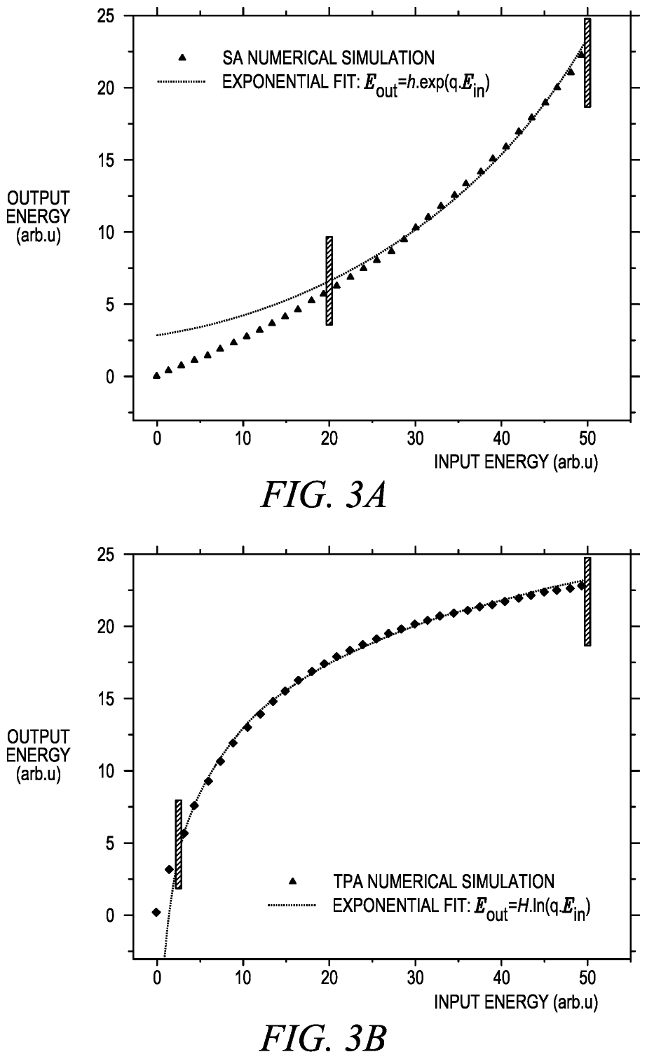

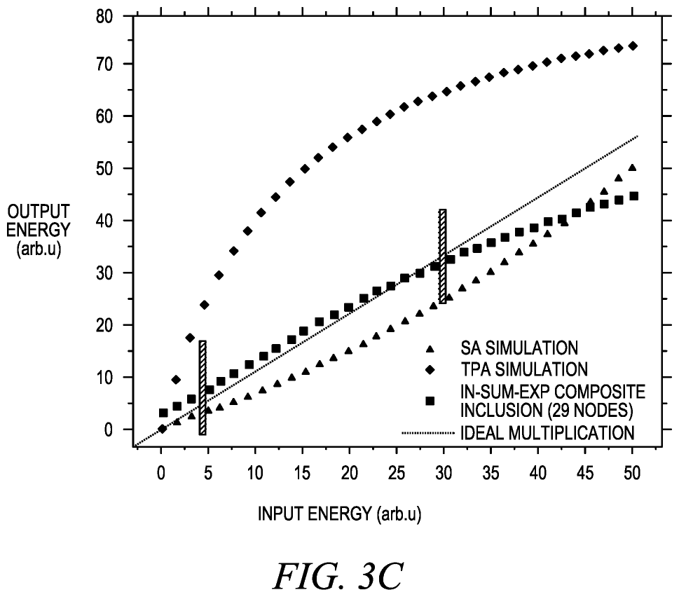

A numerical solution of equation (3) and its fit with an exponential function are plotted in FIG. 3a. Including the two photon absorption term in the nonlinear absorption differential equation dI/dz=−α₀I−βI², leads to an explicit analytical solution,

$${I}_{out} = \frac{{I}_{in} {e}^{- {α}_{0} L}}{1 + β {L}_{eff} {I}_{in}} \qquad ( 4 )$$

where β is the TPA coefficient and L_{eff}=(1−e^{-α}^{ₒ}^{L})/α₀. A numerical solution of equation (4) is plotted in FIG. 3b as well as its fit with a natural logarithm function. The composite mathematical operations of ln-sum-exp for 29 inputs is shown by the squares in FIG. 3c. The ideal multiplication result is plotted as a linear fit in FIG. 3c.

Note that the peak irradiance in equations (3) and (4) can be replaced with energy per pulse (fluence or photon number as well) without any change in concept of their comparison with the exponential and logarithm functions. We use energy per pulse (E) for simulation as the experimental data were measured in terms of energy per pulse. In FIG. 3a and FIG. 3b the range of the fitting was limited in order to get maximum overlap of the exponential and natural logarithm fit functions with SA and TPA solutions. Also, the normalized-root-mean-square error (NRMSE) should be less than 1% and is defined as

$$NRMSE = \frac{\sqrt{〈 {( {E}_{out} - {E}_{fit} )}^{2} 〉}}{{E}_{max} - {E}_{min}} \qquad ( 5 )$$

Limiting the ranges also comes from the natural behavior of the SA and TPA process where equation (3) and (4) start from zero for no input energy. However, we know that e⁰=1 and ln(0) is undefined. Therefore, bounding the input intensity range for the fitting is necessary for convergence and adequate fitting of the solutions of the TPA and SA equations with the target functions. The criteria are the maximum error acceptable to reproduce the function.

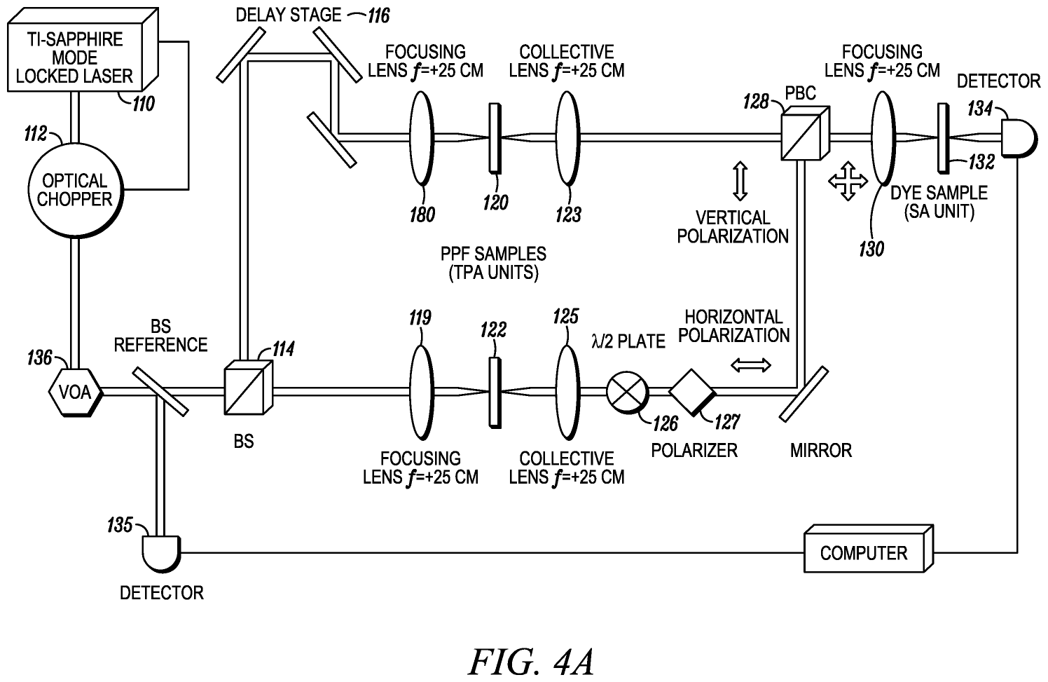

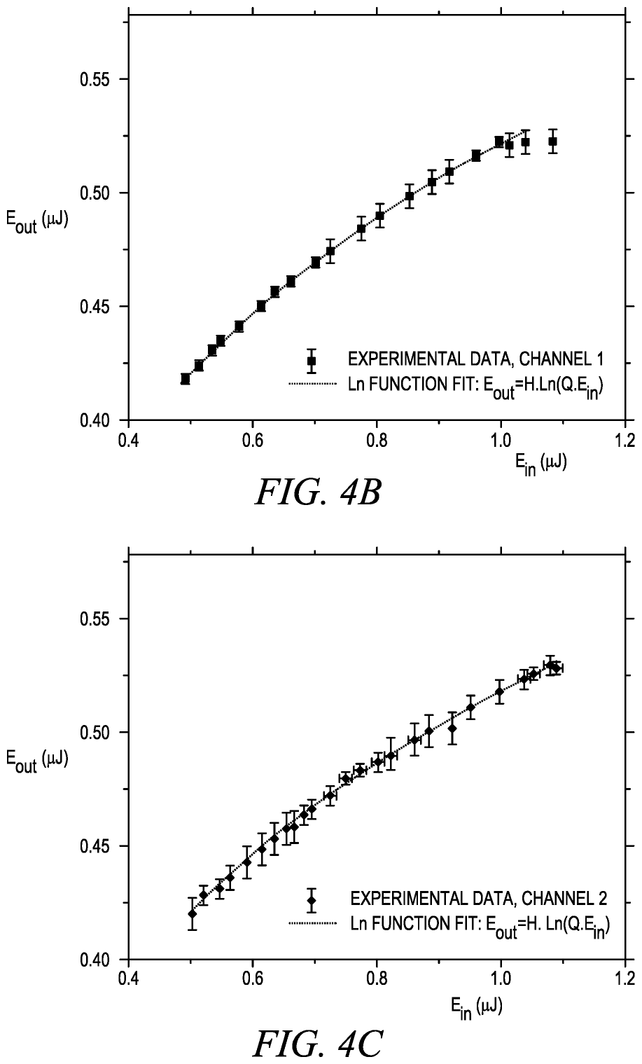

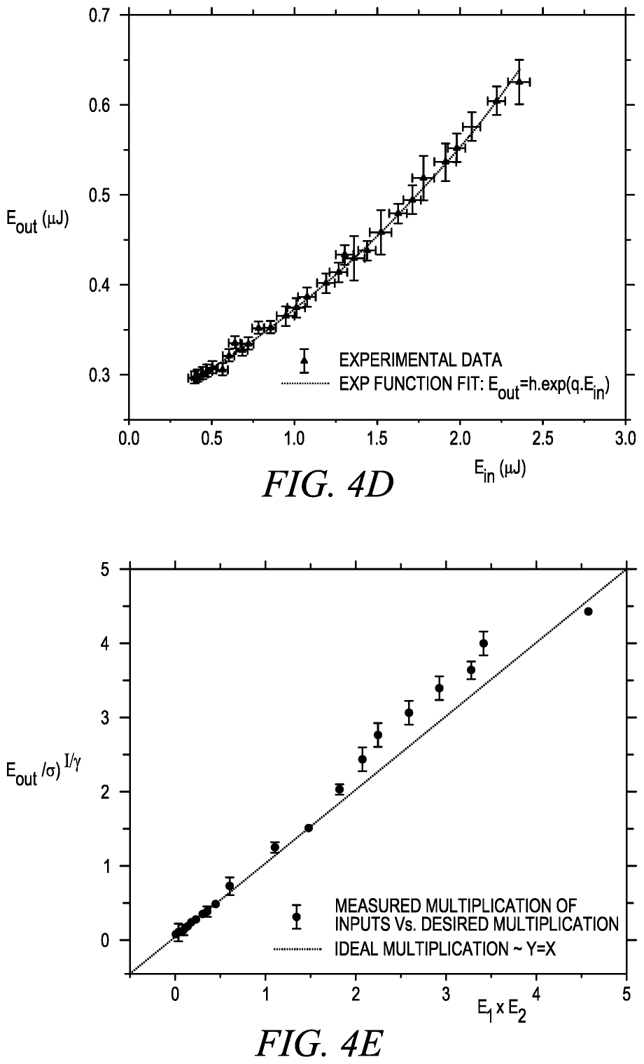

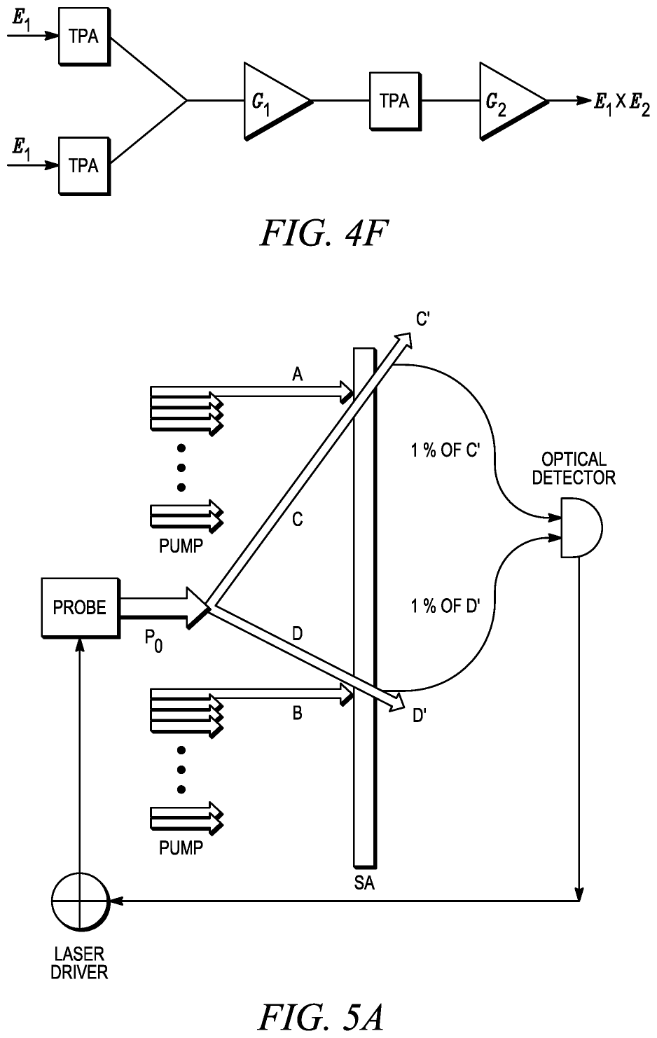

The functional block diagram of the multiplier shown in FIG. 2a was implemented using the arrangement shown in FIG. 4a, which shows the multiplication of two factors represented by the energy levels of two optical signals. As shown, an optical laser source 110 such as a mode-locked laser was used to generate the optical signal. In this example the optical laser source 110 was an 810 nm Ti-Sapphire laser producing 150 fs pulse width (at FWHM) and a 50 Hz repetition rate. The original repetition rate out of the amplifier locked to the laser was 1 kHz. An optical chopper 112 was used to synchronize and externally trigger the phase of the amplifier pulses, which allowed the repetition rate to be reduced to 50 Hz in order to reduce the probability of heat damage and thermal effects in the samples.

The vertically polarized optical beam from the laser source 110 was split into two optical beams by a beam splitter 114. One of the beams traversed a delay stage 116 that is used for pulse synchronization. The optical beams respectively traversed convex lens 118 and 119, which were used to increase the intensity and access the nonlinear absorption behavior of the samples. Each optical beam was then directed onto a respective two-photon absorption material 120 and 121, which in this example was amorphous carbon made by the pyrolyzing photoresist film (PPF) technique and having a thickness of 50±2 nm. The spot size of the beams at the focus was 76 μm. A second pair of convex lenses 123 and 125 were used for collecting and re-collimating the optical beams. A half-wave plate 126 and polarizer 127 were placed in the path of one of the optical beams to rotate the polarization of the beam into a horizontal polarization state to thereby ensure that the two optical beams were in orthogonal polarization states before they were each directed to a polarization beam combiner (PBC) 128, which combined the two optical beams in the orthogonal polarization states. In this way the two beams did not interfere when they were directed onto the saturable absorber 132 after traversing a focusing lens 130 even though both optical beams have the same wavelength. The saturable absorber 132 used in this example was a nonlinear optical dye (i.e., thiopyrylium-terminated heptamethine cyanine) having a thickness of 3 μm. A detector 134 was used to detect the resulting optical signal. A second detector 135, variable optical attenuator (VOA) 136 and a beam splitter (BS) 137 were used to monitor the input energies to the two photon absorption materials 120 and 122.

FIGS. 4b, 4c and 4d show Eₒᵤₜ versus Eᵢₙ and the nonlinear fit functions with the natural logarithm and exponential functions for the TPA materials (FIGS. 4b and 4c) and the SA material (FIG. 4d) shown in FIG. 4a. As expected, according to the TPA and SA simulations, the logarithm and exponential function fits do not have the exact mathematical form of ln(x) and e^{x} due to the weak field, two photon absorption, scattering and the insertion loss from optical components. However, the fit coefficients (H, Q, h, q) are known and constant, so that we can take these coefficients into account as imperfections that cause deviations from the exact mathematical multiplication. Considering the Maclaurin expansion of equation (3) and the fit function in FIG. 4d up to third order, we define the coefficient q to be proportional to α₀ L/IₛₐₜA_{eff} where A_{eff} is the spot size of the optical beam. On the other hand, as explained in connection with FIG. 2a, the composite function of the sum of two natural logarithm functions and subsequent exponentiation yields the product of input values. Taking the fit coefficients from FIG. 4b and FIG. 4c in account, the summation of the two output values from the TPA blocks is:

H.ln(Q.E₁)+H.ln(Q.E₂)=ln[(Q².E₁×E₂)^{H}] (6)

In the arrangement of FIG. 4a the polarization beam combiner (PBC) 128 performs the summation operation and this value ouput by the PBC 128 is the input to the SA 132. The SA 132 operates on the input values based on the fit equation in FIG. 4d:

h. exp [q. ln((Q².E₁×E₂)^{H})]→h(Q^{2H.q})(E₁×E₂)^{H.q} (7)

Equation (7) reduces to σ(E₁×E₂)^{γ} where σ=hQ^{2Hq} and γ=Hq. The numerical values for the experimental set-up and materials that were used are σ=0.375 and γ=0.059. These coefficients capture all of the imperfections and fundamental material characteristics of the set-up. However, to obtain a pure mathematical multiplication of two numbers as desired, two gain elements may be added to arrangement to eliminate the σ and γ coefficients and thereby exactly obtain E₁×E₂.

FIG. 4f shows a modified functional block diagram of the optical implementation of the multiplier function shown in FIG. 2a. As shown, the functional block diagram of FIG. 4f adds gain stages G₁ and G₂. Gain stage G₁ provides gain equal to 1/γ and gain stage G₂ provides gain equal to 1/(hQ²). Note that, based on conservation of energy, it is fundamentally not possible to take two energy values and detect their direct multiplication. Hence, adding gain stages is a reasonable approach, although it increases the power consumption of the computation. However, in order to multiply more than two numbers in which σ or γ or both become greater than one, attenuation stages need to be added instead of gain stages. The selection of gain stage(s) or attenuation stages (s) depends on the size of the graph, number of edges and the material characteristics.

FIG. 4e shows the measured output energy obtained by the detector 134 as a result of appropriate manipulations of the two inputs, versus the desired multiplication of the two numbers. The optical constants σ and γ have been included in the output values to demonstrate that the simulation matches with the experiment. As can be seen, the range of E₁×E₂ values between 0 to 1.3 has a minimum error of less than 1%, as expected. Based on FIG. 4b and FIG. 4c, the dynamic range for which the TPA materials implement the natural logarithm function is between 0.5 μJ to 1.1 μJ (3.5 dB). Therefore, multiplication of these numbers results in a maximum of 1.21. For numbers outside of the dynamic range of the TPA and SA stages, the output values exhibit a greater deviation from the desired multiplication values as can be seen from a comparison with the solid line in FIG. 4e, which represents ideal multiplication.

While FIG. 4a illustrates an example of an arrangement for optically implementing a multiplication function in accordance with the techniques described herein, those of ordinary skill in the art will recognize that these techniques may be implemented using a wide variety of different optical arrangements and systems. Moreover, the arrangements are not limited to the use of the particular TPA or SA materials described herein. More generally, any TPA or SA material may be used, provided that the TPA material that is selected is able to provide an optical output power that is within the input dynamic range of the selected SA material.

Normalization

According to equation (1) the normalization factor (Z) must be taken into account to ensure that the probability vector distribution is mapped between zero and one. For normalizing the probabilities that are obtained from the multiplication of each node, an optical pump-probe saturation arrangement was used, followed by an electrical feedback-loop system. For this operation, a SA was employed such that by increasing or decreasing the pump intensity, approaching saturation, the optical intensity of the probe beam can be increased or decreased.

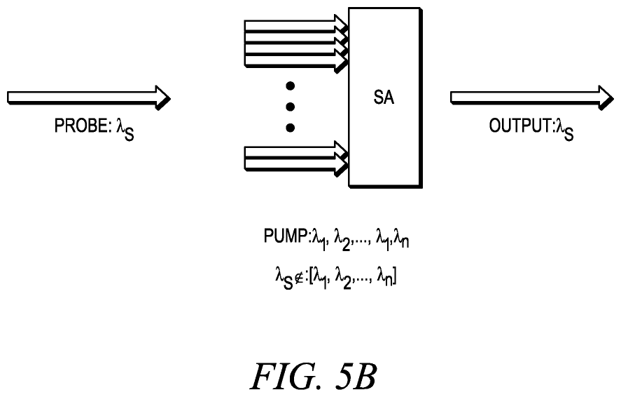

FIG. 5a shows a functional block diagram of the optical implementation of the normalization function for two broadband (multi-wavelength) power inputs A and B that represent two numbers to be normalized. The SA is used to (1) make the sum of all elements of each normalized probability vector constant and (2) integrate over the input spectrum and translate to a proper node-specific output wavelength. An adjustable optical probe beam power P₀ is split equally into probe powers C and D that are respectively applied to the portion of the SA onto which the power inputs A and B are directed. In the feedback-loop, the adjustable optical probe beam power P₀ is such that for any value of A and B, C′+D′ remains constant, where C′=P₀A/(A+B) and D′=P₀B/(A+B).

According to the message passing algorithm, implemented via a wavelength multiplexing approach, the information in the probability vector should be recirculated for the next iteration and they must be monochromatic. However, the receipt node receives multiple wavelengths from the pump. The pump is a broadband coherent source that enforces the value of the probability vectors and the probe is a constant signal at the node's wavelength. The output power is modulated with pump intensity and has the same wavelength as the probe. It should also be noted that the individual elements of the probability vector must be spatially separated in the SA. Thus the element will be modulated separately in the presence of pump intensity. FIG. 5b shows a schematic of the wavelength remapping through the pump-probe saturation process, where each element of the probability vector is modulated in the presence of a broadband pump, requiring spatial separation in the saturable absorber (SA).

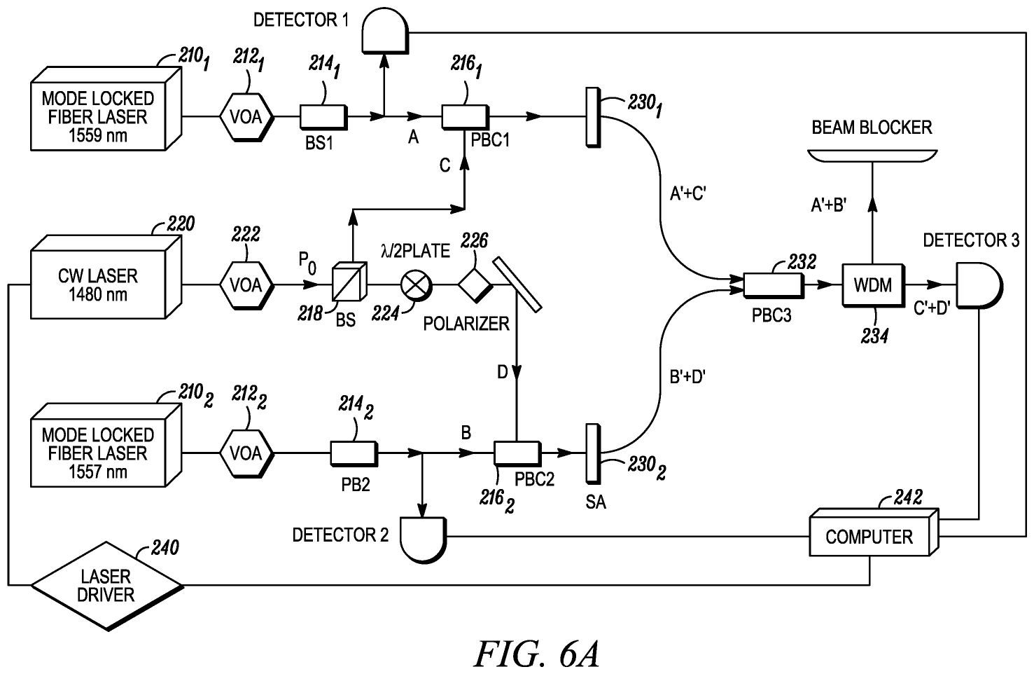

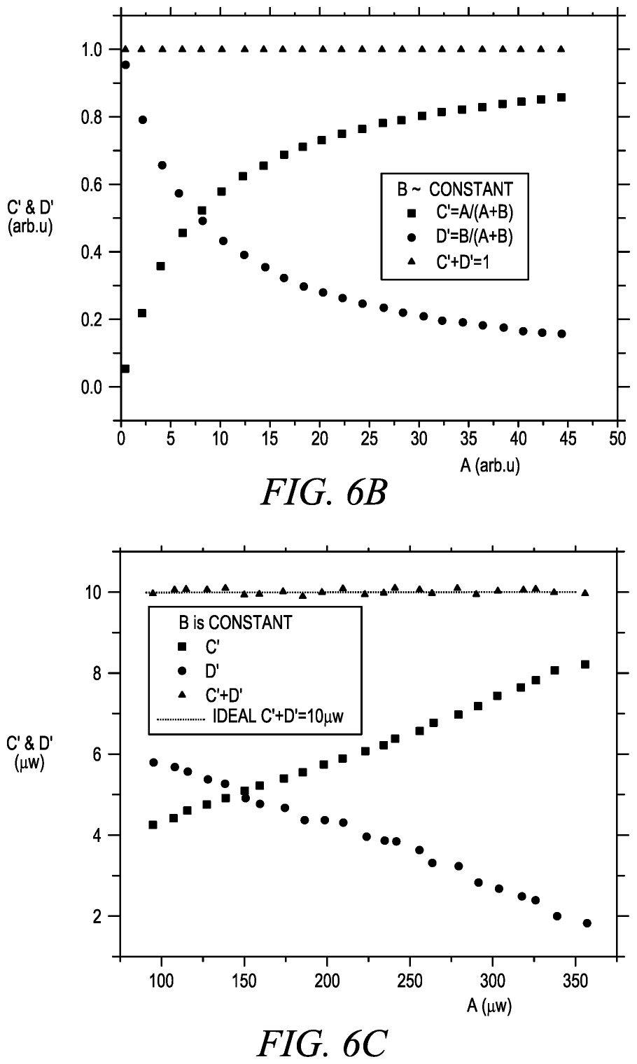

FIG. 6a shows one example of an experimental arrangement that was employed for normalizing two optical powers. Two femtosecond mode-locked fiber lasers 210₁ and 210₂ were used as the pump sources to provide power inputs A and B. A CW laser source 220 was used to generate the optical probe beam power P₀. The mode-locked fiber laser 210₁ generated a wavelength λ_{A}=1559 nm with an 8 MHz repetition rate and a 200 fs pulse width, and the mode-locked fiber laser 210₂ generated a wavelength λ_{B}=1557 nm with a 109 MHz repetition rate and a 240 fs pulse width. The CW laser source 220 generated a continuous wave (CW) optical beam at a probe wavelength λ_{Probe}=1480 nm. While the wavelengths λ_{A} and λ_{B} in this particular arrangement are relatively close to one another, more generally these wavelengths may be the same or different from one another.

A beam splitter 218 was used to split the optical probe beam power P₀ into probe powers C and D. A half-wavelength plate 224 and a polarizer 226 were used in the path of one of the probe powers (probe power D) to rotate its polarization state and thereby avoid interference at detector 3. Beam splitters 2141 and 2142 were used to provide a small portion of power inputs A and B to detectors 1 and 2 for power monitoring of power inputs A and B, respectively. Polarization beam combiner 2161 combined power input A with probe power C and polarization beam combiner 2162 combined power input B with probe power D while preserving their polarizations. Combined optical powers A+C were made collinear at SA 230₁ and combined optical powers B+D were made collinear at SA 230₂. In this way the powers of C and D were modulated in the presence of pump inputs A and B, respectively. SA 230₁ and SA 230₂ were formed from chemical vapor deposition (CVD) grown graphitic pyro-carbon (GrPyC) thin films that were transferred onto two fiber tips as the SAs. The thickness of the two SAs was 50±2 nm. Polarization beam combiner 232 combined the optical powers A′+C′ from the SA 230₁ with the optical powers B′+D′ from the SA 230₂. A wavelength-division multiplexer (WDM) 234 separated the wavelength of the probe powers C′ and D′ (equal to the wavelength provided by the cw laser source 220) from the two wavelengths A′ and B′. This is possible because the wavelengths of power inputs A′ and B′, which are equal to the wavelengths provided by mode-locked fiber lasers 210₁ and 210₂, respectively, were chosen to be close to one another.

An electronic feedback-loop system was used to control the probe laser power from the CW laser source 220 such that C′+D′ remained constant for arbitrary values of power inputs A and B. The feedback-loop system includes a laser driver 240 for driving the CW laser source 220 based on feedback signals from a processor 242. The feedback signals generated by the processor 242 are based on signals received from detectors 1, 2 and 3, which measured the pump input A, the pump input B, and the probe power C′+D′, respectively. However, this feedback-loop system has a finite dynamic range where probe powers C and D can be modulated in the presence of pump inputs A and B due to the weak field and nonlinear absorption range of SAs, as well as the damage thresholds of the samples. A LabVIEW-based code (from National Instruments) was used for the feedback-loop system and adjusted the power output of the probe laser based on the reading from the three power detectors 1, 2 and 3.

FIG. 6b shows the simulation results of an ideal normalization of two input powers A and B and the result of C′+D′=1 (arbitrary units). Here we assume that the pump input B is constant and the feedback-loop mechanism is employed to control P₀ such that C′+D′ remains constant. FIG. 6c shows the experimental results and demonstrates good agreement with the simulation. In the experiment pump input B was maintained at a constant value of 100 μW and the output of the CW laser after SAs was 10 μW, which is the desired constant value that we use of a want to achieve in presence of input powers A and B. It has been shown that increasing the intensity of laser 210₁, which generates input power A, increases the output of the probe laser at the corresponding arm, C′, and accordingly, the output in the other arm, D′, decreases because of the feedback-loop that keeps C′+D′ almost constant. The NRMSE of the experimental result versus the ideal normalization in FIG. 6c (solid line) is about 1%.

While FIG. 6a illustrates an example of an arrangement for optically implementing a normalization function in accordance with the techniques described herein, those of ordinary skill in the art will recognize that these techniques may be implements using a wide variety of different optical arrangements and systems. For instance, as mentioned above in connection with the arrangement for optically implementing a multiplication function, the arrangements for implementing a normalization function are not limited to the use of the particular TPA or SA materials described herein. More generally, any TPA or SA material may be used, provided that the TPA material that is selected is able to provide an optical output power that is within the input dynamic range of the selected SA material. In addition, while the embodiment shown in FIG. 6a shows the use of two SAs that each receive one of the combined power input and probe power signals (optical powers A′+C′ and B′+D′), in other embodiments only a single SA may be used, with each of the combined power input and probe power signals being directed onto spatially separated parts of the single SA.

Conclusion

One of the major challenges in the wavelength multiplexing architecture to solve PGMs is the scalability for a very large number of nodes (e.g. 10⁶). Hypothetically, increasing the spectral bandwidth of the coherent laser sources can result in an increase of the number of nodes. However, considering the current coherent source technologies, dividing the spectral bandwidth of the coherent source to a very large number in order to represent each node reduces the peak irradiance by several order of magnitudes. This reduction of the peak irradiance does not leave enough fluence to access the nonlinear TPA and SA behaviors of many known nonlinear optical materials in nature. However, materials engineering may provide a route towards tuning the atomic line-shape so that the lifetime can be longer. Coupling this with the tuning of the input frequency to that of one and two photon excited states can enhance the cross section of TPA and SA processes such that a lower peak irradiance TPA and SA can be achieved. We investigated both theoretically and experimentally the essential required mathematical functions to optically implement the message passing algorithm for probabilistic graphical models. The two basic and central mathematical operations, multiplication (through natural logarithm-sum-exponent operation) and division (normalization), which are required for the SPMPA, were optically implemented.

Nonlinear thin film optical materials were employed for the TPA (PPF) and the SA (thiopyrylium-terminated heptamethine cyanine) to demonstrate the optical implementation of the natural logarithm and exponentiation functions, respectively. We also used another type of nonlinear thin film as a saturable absorber (GrPyC) to implement normalization through a pump-probe-saturation experiment. Furthermore, with respect to the enormous breadth of applications that these two fundamental mathematical operations (multiplication and division) provide, the techniques described herein can be widely used to enable these operations.

To estimate the speed of computation of the proposed optical PGM arrangement, we note that the multi photon excitation processes in the SA and TPA components, are extremely fast, in the sub-femtosecond range. So the rates of generating and detection of the light are the primary time constraint of the overall system. For pulsed lasers the repetition rates can be greater than 100 Gbps while photodetectors can be as fast as 100 GHz as well. It should be noted that one of the advantages of optical analog computation is that the speed of calculation will not increase as the problem increases in scale. Contrary to their analogous electrical devices, all the mathematical units presented here (ln, sum, exp and norm) use optical components that do not require an external source of energy to perform the operation on the signal. In principle, using such passive elements could be a great benefit in terms of energy consumption. However, optical insertion loss, as well as linear and nonlinear absorptions should be included in the energy budget, especially when the signal (which carries the energy) needs to be recirculated and when performing cascading operations. For this reason, buffering amplifiers may be required for optical implementation of the SPMPA approach for the PGMs. As a proof-of-concept an optical implementation of the PGM message passing algorithm for a two node graph (N=2) has been successfully demonstrated.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

1. A method of multiplying together a series of factors, comprising:
representing a multiplication operation in terms of a summation of a series of natural logarithmic functions that undergo exponentiation to represent the multiplication of the factors;
generating an optical signal for each of the factors to be multiplied, each optical signal having a power or energy level that represents its respective factor;
applying each of the optical signals to a respective material that undergoes a two-photon absorption process to implement a natural logarithm function;
directing each optical output signal output by the materials to an optical combiner to obtain a summed optical signal; and
directing the summed optical signal to a saturable absorber to implement an exponential function, the power or energy of the resulting optical output signal from the saturable absorber representing the product of the factors to be multiplied.

2. The method of claim 1, wherein the materials that undergo a two-photon absorption process comprise amorphous carbon.

3. The method of claim 1, wherein the saturable absorber comprises a nonlinear optical dye.

4. The method of claim 3, wherein the nonlinear optical die comprises thiopyrylium-terminated heptamethine cyanine.

5. The method of claim 1, wherein the optical signals for each of the factors are pulsed optical beams provided by at least one mode-locked laser.

6. The method of claim 1, wherein the optical output signals output by the materials that undergo a two-photon absorption process are in orthogonal polarization states and the optical combiner is a polarization beam combiner.

7. A method for normalizing at least two numbers represented by first and second optical pump powers, comprising:
directing the first and second optical pump powers to spatially separated regions of at least one saturable absorber, respectively;
splitting an optical probe beam into first and second optical probes that are equal in power;
applying the first and second optical probes to the at least one saturable absorber at the respective spatially separated regions onto which the first and second optical pump powers are respectively directed; and
adjusting a power level of the optical probe beam using a feedback signal such that a sum of a first output probe power from the at least one saturable absorber and a second output probe power from the at least one saturable absorber remains constant, the first and second output powers representing the normalized values of the two numbers.

8. The method of claim 7, wherein the at least one saturable absorber comprises first and second saturable absorbers such that the first optical pump power is directed onto the first saturable absorber and the second optical pump power is directed on the second saturable absorber.

9. The method of claim 7, wherein the first and second optical pump powers have a common optical wavelength.

10. The method of claim 7, wherein the first and second optical pump powers have different optical wavelengths.

11. The method of claim 1, wherein the optical probe beam is a continuous-wave (cw) optical beam.

12. The method of claim 1, wherein the first and second optical pump powers are pulsed optical beams provided by mode-locked lasers.

13. The method of claim 1, wherein the first and second saturable absorbers comprise graphitic pyro-carbon (GrPyC)
